(19) United States
(12) Patent Application Publication
(10) Pub. No.: US 2026/0167817 A1
(43) Pub. Date: Jun. 18, 2026

(54) POLYESTER AQUEOUS DISPERSIONS

(71) Applicant: Dow Global Technologies LLC, Midland, MI (US)

(72) Inventors: Xiangtao Meng, Manvel, TX (US); David L. Malotky, Midland, MI (US)

(21) Appl. No.: 19/125,328

(22) PCT Filed: Nov. 13, 2023
(86) PCT No.: PCT/US2023/079483

§ 371 Date: Apr. 29, 2025

Related U.S. Application Data
(60) Provisional application No. 63/425,330, filed on Nov. 15, 2022.

(51) Int. Cl. C08L 67/02; C08J 3/03; C08J 5/18; C09D 11/106

(52) U.S. Cl. CPC C08L 67/02; C08J 3/03; C08J 5/18; C09D 11/106

(57) ABSTRACT

An aqueous dispersion includes water, a dispersing agent, a polyamine having 3 or more amino groups and a plurality of particles of polyester. The polyester is aliphatic and has a glass transition temperature of 50° C. or less or less as measured according to ASTM E1356-08.

### BACKGROUND

### Field of the Disclosure

The present disclosure is related to aqueous dispersions and more specifically to aqueous dispersions that comprise polyester and polyamines.

### INTRODUCTION

Films and coatings are applied to a variety of articles such as seeds, paper products and crop additives. Traditional materials used for forming films and coatings on these articles have included polymer latexes such as acrylates and polyvinyl acetate. Typically, an aqueous dispersion of the film forming materials is applied to the article and then cured to form the film. Recently, there has been increasing regulatory pressure on such films due to perceived lack of biodegradability and other environmental concerns posed by the constituents of the film.

Achieving the same level of performance in films and coatings provided by traditional materials, but using readily biodegradable materials, is challenging. Specifically, biodegradable materials struggle to achieve comparable results to traditional materials in terms of water resistance. A film's water resistance is typically measured in terms of turbidity, formed by the film (sometimes with addition of small amount of pigment) when submerged in water, and on a visual rating of the film after exposure to water. Achieving a turbidity value of 50 or less as measured according to Turbidity Testing and a visual rating of 5 or greater as measured according to Visual Water Resistance Testing typically means a film exhibits effective water resistance. An additional concern of using readily biodegradable materials is the additional manufacturing steps that may be necessary. Some biodegradable materials may require a curing step at an elevated temperature above 50° C. to form a water resistant and/or suitable barrier. Such a high cure temperature may harm the article on which the film is formed. It would be advantageous from a cost and manufacturing complexity step if no high temperature cure step was required.

Despite the complexities faced by creating biodegradable films, there have been attempts. For example, World Intellectual Property Organization Publication number 2022003195A1 (“the '195 publication”) discloses the use of biopolymer film dispersions that have been strengthened through the use of a cross linking agent. The biopolymer of the '195 publication may be a polyester and a dispersant used for the biopolymer is polyvinyl alcohol. The crosslinking agents include di-functional amines and operate to crosslink the polyvinyl alcohol to form a film through the use of dicarboxylic acid moieties, but require an elevated temperature of about 130° C. to cure the film.

In view of the foregoing, it would be surprising to discover an aqueous dispersion capable of creating a film that achieves a turbidity value of 50 or less as measured according to Turbidity Testing and a visual rating of 5 or greater as measured according to Visual Water Resistance Testing without the need for a cure step above 50° C.

### SUMMARY OF THE DISCLOSURE

The inventors of the present disclosure have discovered an aqueous dispersion capable of creating a film that achieves a turbidity value of 50 or less as measured according to Turbidity Testing and a visual rating of 5 or greater as measured according to Visual Water Resistance Testing without the need for a cure step above 50° C.

The present disclosure is the result of discovering that aqueous dispersions of polyester particles can form water resistant biodegradable films by directly crosslinking the polyester rather than its dispersants (i.e., polyvinyl alcohol). In order to achieve this direct crosslinking of the polyester particles, the polyester should have a glass transition temperature (“Tg”) of 50° C. or less and the crosslinking agent is a polyamine having 3 or more amino groups. Without being bound by theory, it is believed that polyesters having a Tg of greater than 50° C. do not exhibit sufficient chain mobility to provide bonding locations for cross-linking agents to react with. In other words, the steric hindrance of polyesters having a Tg of greater than 50° C. is too great for the cross-linking agent to effectively bond the polyester particles together. Additionally, the crosslinking agent used must have sufficient amino functional groups to not only overcome the steric hindrance of the polyester, but also bind two or more polyester particles together. It has been discovered that two amino functional groups is not sufficient on its own to, even with the appropriate polyester, to achieve the desired turbidity and visual rating targets. Rather, the combination of a polyester having a Tg of 50° C. or less and polyamine having 3 or more amino groups is able to form films that not only meet but exceed the turbidity and visual rating targets. Further, by selecting a polyester having a Tg of 50° C. or less, the film does not require a heating step in order to cure because there will be sufficient chain mobility for bonding.

According to a first feature of the present disclosure, an aqueous dispersion comprises water, a dispersing agent, a polyamine having 3 or more amino groups and a plurality of particles of polyester, wherein the polyester is aliphatic and has a glass transition temperature of 50° C. or less or less as measured according to ASTM E1356-08.

According to a second feature of the present disclosure, the dispersing agent is selected from the group consisting of polyvinyl alcohol, fatty alcohol ethoxylates, ethylene oxide/propylene oxide block copolymers, salts of fatty acids and mixtures thereof.

According to a third feature of the present disclosure, the polyester particles have a volume mean size of from 100 nm to 1500 nm as measured according to Particle Size Testing.

According to a fourth feature of the present disclosure, the aqueous dispersion comprises 1 wt % to 20 wt % of the dispersing agent based on the total weight of the aqueous dispersion, 0.05 wt % to 5 wt % of the polyamine based on the total weight of the aqueous dispersion, and 20 wt % to 60 wt % of the polyester particles based on the total weight of the aqueous dispersion.

According to a fifth feature of the present disclosure, the polyamine is selected from the group consisting of polyethylenimine, chitosan, diethylenetriamine, triethylenetetramine and combinations thereof.

According to a sixth feature of the present disclosure, the aqueous dispersion comprises from 0.1 wt % to 1.0 wt % of the polyamine based on a total weight of the aqueous dispersion.

According to a seventh feature of the present disclosure, the glass transition temperature is from −70° C. to 20° C.

According to an eighth feature of the present disclosure, the polyester is selected from the group consisting of polycaprolactone, poly(3-hydroxybutyrate-co-3-hydroxyhexanoate), poly(3-hydroxybutyrate-co-3-hydroxy valerate), polyhydroxyalkanoate, polybutylene adipate terephthalate, polybutylene succinate, polybutylene succinate adipate, poly(3-hydroxybutyrate), and mixtures thereof.

According to a ninth feature of the present disclosure, a method of forming a film, comprises the steps of applying the aqueous dispersion of any one of claims 1-8 to an article, and curing the aqueous dispersion at a temperature of 10° C. to 50° C. to form a film.

According to a tenth feature of the present disclosure, the article is selected from the group consisting of a seed, a paper article, and a crop additive.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

As used herein, the term weight percent (“wt. %”) designates the percentage by weight a component is of a total weight of the glycol composition unless otherwise specified.

As used herein, Chemical Abstract Services registration numbers (“CAS #”) refer to the unique numeric identifier as most recently assigned as of the priority date of this document to a chemical compound by the Chemical Abstracts Service.

Unless otherwise denoted, all molecular weight measurements herein are determined according to Gas Chromatography with Mass Spectrometry Detection as explained below.

### Aqueous Dispersion

The present disclosure is directed to an aqueous dispersion and the resulting films formed form it. The aqueous dispersion comprises water, a dispersing agent, a polyamine and a polyester. The aqueous dispersion may be used to form films on surfaces and articles.

The aqueous dispersion may have from 15 wt % to 80 wt % water based on the total weight of the aqueous dispersion. For example, the aqueous dispersion may comprise 15 wt % or greater, or 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, while at the same time, 80 wt % or less, or 75 wt % or less, or 70 wt % or less, or 65 wt % or less, or 60 wt % or less, or 55 wt % or less, or 50 wt % or less, or 45 wt % or less, or 40 wt % or less, or 35 wt % or less, or 30 wt % or less, or 25 wt % or less, or 20 wt % or less water based on the total weight of the aqueous composition.

The aqueous dispersions can be formed by various processes recognized by those having skill in the art. For example, the polyester may be combined with one or more, dispersing agents and then melt-kneaded with water in an extruder (e.g. via a BLUEWAVE™ process) in a continuous fashion to form a melt blended emulsion product. Water and one or more dispersing agents can also be utilized to form the aqueous dispersion in a batch melt process. In either the continuous or batch process the process, temperature must be greater than the melting temperature of the polyester. When the temperature of the forming process is 100° C. or greater, the pressure in the process must be controlled to be greater than the steam pressure at the process temperature.

The aqueous dispersion can comprise a solids content of 15 wt % to 70 wt % based on the total weight of the aqueous dispersion. For example, the aqueous dispersion can have a solids content of 15 wt % or greater, or 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, while at the same time, 70 wt % or less, or 65 wt % or less, or 60 wt % or less, or 55 wt % or less, or 50 wt % or less, or 45 wt % or less, or 40 wt % or less, or 35 wt % or less, or 30 wt % or less, or 25 wt % or less, or 20 wt % or less. The solids content of the aqueous dispersion is measured using an infrared solids analyzer such as an OHAUS® MB45 Moisture Analyzer or similar device.

The aqueous dispersion may have a viscosity of 5 Pas or less, or 4 Pa*s or less, or 3 Pa*s or less, or 2 Pas or less, or 1 Pa*s or less as measured using an RV viscometer at 50 revolutions per minute using the appropriate spindle for the given viscosity.

### Dispersing Agent

As used herein, a “dispersing agent” is a substance that is added to the melt emulsification process to aid in the formation of emulsion particles and to enable the suspension of solid particles in a liquid to improve the separation of the particles and to prevent the settling or clumping of the particles. The dispersing agent may be selected from the group consisting of polyvinyl alcohol, fatty alcohol ethoxylates, ethylene oxide/propylene oxide block copolymers, salts of fatty acids, water dispersible sulfonated polyesters, and mixtures thereof.

In examples utilizing polyvinyl alcohol, the polyvinyl alcohol used may be 88% to 98% saponified, with viscosity (mPa*sec of a 4% aqueous solution at 20° C.) less than 30, preferably viscosity less than 10. Examples of commercially available PVA include Poval™ 4-88 available from Kuraray Co., Ltd.; Poval™ 6-88, available from Kuraray Co., Ltd.; Poval™ 18-88, available from Kuraray Co., Ltd.; Poval™ 10-98, available from Kuraray Co., Ltd.; Selvol™ E310, available from Sekisui Specialty Chemicals America, and also terminal hydrophobically modified material such as Exceval® RS-2117, available from Kuraray Co., Ltd.; and blends thereof.

The aqueous dispersion may comprise from 1 wt % to 20 wt % of the dispersing agent based on the total weight of the aqueous dispersion. For example, the aqueous dispersion may comprise 1 wt % or greater, or 2 wt % or greater, or 4 wt % or greater, or 6 wt % or greater, or 8 wt % or greater, or 10 wt % or greater, or 12 wt % or greater, or 14 wt % or greater, or 16 wt % or greater, or 18 wt % or greater, while at the same time, 20 wt % or less, or 18 wt % or less, or 16 wt % or less, or 14 wt % or less, or 12 wt % or less, or 10 wt % or less, or 8 wt % or less, or 6 wt % or less, or 4 wt % or less, or 2 wt % or less of the dispersing agent based on the total weight of the aqueous dispersion.

### Polyamine

The polyamine used in the aqueous dispersion is a polyamine having 3 or more amino groups. As defined herein, an amino group is a nitrogen atom bonded to two hydrogen atoms and which is capable of undergoing aminolysis to form an amide bond with the polyester. The polyamine may have 3 or more amino groups, 4 or more amino groups, 5 or more amino groups, 6 or more amino groups, 7 or more amino groups, 8 or more amino groups, 9 or more amino groups or 10 or more amino groups, or 50 or more amino groups, or 100 or more amino groups, or 200 or more amino groups, or 300 or more amino groups, or 400 or more amino groups, or 500 or more amino groups, or 600 or more amino groups, or 700 or more amino groups, or 800 or more amino groups, or 900 or more amino groups, or 1000 or more amino groups. Each of the amino groups present on the polyamine may be independently one of a primary amino group, a secondary amino group or a tertiary amino group.

The polyamine is selected from the group consisting of polyethylenimine, chitosan, diethylenetriamine, triethylenetetramine and combinations thereof.

The aqueous dispersion may comprise from 0.05 wt % to 5 wt % of the polyamine based on the total weight of the aqueous dispersion. For example, the aqueous dispersion may comprise 0.05 wt % or greater, or 0.1 wt % or greater, or 0.5 wt % or greater, or 1.0 wt % or greater, or 1.5 wt % or greater, or 2.0 wt % or greater, or 2.5 wt % or greater, or 3.0 wt % or greater, or 3.5 wt % or greater, or 4.0 wt % or greater, or 4.5 wt % or greater, while at the same time, 5.0 wt % or less, or 4.5 wt % or less, or 4.0 wt % or less, or 3.5 wt % or less, or 3.0 wt % or less, or 2.5 wt % or less, or 2.0 wt % or less, or 1.5 wt % or less, or 1.0 wt % or less, or 0.5 wt % or less, or 0.1 wt % or less of the polyamine based on the total weight of the aqueous dispersion

### Polyester

The aqueous dispersion comprises a plurality of particles of polyester. The polyester has a glass transition temperature of 50° C. or less as measured according to ASTM E1356-08. For example, the polyester may have a glass transition temperature of −100° C. or greater, or −95° C. or greater, or −90° C. or greater, or −85° C. or greater, or −80° C. or greater, or −75° C. or greater, −70° C. or greater, or −65° C. or greater, or −60° C. or greater, or −55° C. or greater, or −50° C. or greater, or −45° C. or greater, or −40° C. or greater, or −35° C. or greater, or −30° C. or greater, or −25° C. or greater, or −20° C. or greater, or −15° C. or greater, or −10° C. or greater, or −5° C. or greater, or 0° C. or greater, or 5° C. or greater, or 10° C. or greater, or 15° C. or greater, or 20° C. or greater, or 25° C. or greater, or 30° C. or greater, or 35° C. or greater, or 40° C. or greater, or 45° C. or greater, while at the same time, 50° C. or less, or 45° C. or less, or 40° C. or less, or 35° C. or less, or 30° C. or less, or 25° C. or less, or 20° C. or less, or 15° C. or less, or 10° C. or less, or 5° C. or less, or 0° C. or less, or −5° C. or less, or −10° C. or less, or −15° C. or less, or −20° C. or less, or −25° C. or less, or −30° C. or less, or −35° C. or less, or −40° C. or less, or −45° C. or less, or −50° C. or less, or −55° C. or less, or −60° C. or less, or −65° C. or less, or −70° C. or less, or −75° C. or less, or −80° C. or less, or −85° C. or less, or −90° C. or less, or −95° C. or less as measured according to ASTM E1356-08.

The polyester may have a weight average molecular weight from 5,000 grams per mole (“g/mol”) to 100,000 g/mol as measured according to gel permeation chromatography. For example, the polyester may have a weight average molecular weight of 5,000 g/mol or greater, or 10,000 g/mol or greater, or 15,000 g/mol or greater, or 20,000 g/mol or greater, or 25,000 g/mol or greater, or 30,000 g/mol or greater, or 35,000 g/mol or greater, or 40,000 g/mol or greater, or 45,000 g/mol or greater, or 50,000 g/mol or greater, or 55,000 g/mol or greater, or 60,000 g/mol or greater, or 65,000 g/mol or greater, or 70,000 g/mol or greater, or 75,000 g/mol or greater, or 80,000 g/mol or greater, or 85,000 g/mol or greater, or 90,000 g/mol or greater, or 95,000 g/mol or greater, while at the same time, 100,000 g/mol or less, or 95,000 g/mol or less, or 90,000 g/mol or less, or 85,000 g/mol or less, or 80,000 g/mol or less, or 75,000 g/mol or less, or 70,000 g/mol or less, or 65,000 g/mol or less, or 60,000 g/mol or less, or 55,000 g/mol or less, or 50,000 g/mol or less, or 45,000 g/mol or less, or 40,000 g/mol or less, or 35,000 g/mol or less, or 30,000 g/mol or less, or 25,000 g/mol or less, or 20,000 g/mol or less, or 15,000 g/mol or less, or 10,000 g/mol or less as measured according to gel permeation chromatography.

The polyester is an aliphatic polyester. As used therein, the term “aliphatic” in relation to the polyester means that the carbon bonds of the polyester for open chains and not rings (i.e., the polyester is not aromatic). The polyester may be selected from the group consisting of polycaprolactone, poly(3-hydroxybutyrate-co-3-hydroxyhexanoate), poly(3-hydroxybutyrate-co-3-hydroxy valerate), polyhydroxyalkanoate, polybutylene adipate terephthalate, polybutylene succinate, polybutylene succinate adipate, poly(3-hydroxybutyrate), and mixtures thereof.

The plurality of polyester particles may have a volume mean (“Vmean”) size from 100 nm to 1500 nm as measured according to Particle Size Testing. As used herein, the term “volume mean” is the diameter of a particle whose volume, if multiplied by the total number of particles, will equate all of the sample's volume. The polyester particles may have a Vmean particle size of 100 nm or greater, or 150 nm or greater, or 200 nm or greater, or 250 nm or greater, or 300 nm or greater, or 350 nm or greater, or 400 nm or greater, or 450 nm or greater, or 500 nm or greater, or 550 nm or greater, or 600 nm or greater, or 650 nm or greater, or 700 nm or greater, or 750 nm or greater, or 800 nm or greater, or 850 nm or greater, or 900 nm or greater, or 950 nm or greater, or 1000 nm or greater, or 1050 nm or greater, or 1100 nm or greater, or 1150 nm or greater, or 1200 nm or greater, or 1250 nm or greater, or 1300 nm or greater, or 1350 nm or greater, or 1400 nm or greater, or 1450 nm or greater, while at the same time, 1500 nm or less, or 1450 nm or less, or 1400 nm or less, or 1350 nm or less, or 1300 nm or less, or 1250 nm or less, or 1200 nm or less, or 1150 nm or less, or 1100 nm or less, or 1050 nm or less, or 1000 nm or less, or 950 nm or less, or 900 nm or less, or 850 nm or less, or 800 nm or less, or 750 nm or less, or 700 nm or less, or 650 nm or less, or 600 nm or less, or 550 nm or less, or 500 nm or less, or 450 nm or less, or 400 nm or less, or 350 nm or less, or 300 nm or less, or 250 nm or less, or 200 nm or less, or 150 nm or less as measured according to Particle Size Testing.

The aqueous dispersion comprises from 20 wt % to 60 wt % of the polyester particles based on the total weight of the aqueous dispersion. For example, the aqueous dispersion comprises 20 wt % or greater, or 25 wt % or greater, or 30 wt % or greater, or 35 wt % or greater, or 40 wt % or greater, or 45 wt % or greater, or 50 wt % or greater, or 55 wt % or greater, while at the same time, 60 wt % or less, or 55 wt % or less, or 50 wt % or less, or 45 wt % or less, or 40 wt % or less, or 35 wt % or less, or 30 wt % or less, or 25 wt % or less based on the total weight of the aqueous dispersion.

The aqueous dispersion has a dispersing agent to polyester particle weight ratio of 10:90 to 40:60. For example, the dispersing agent to polyester particle weight ratio may be 10:90 or greater, or 20:80 or greater, or 30:70 or greater, while at the same time, 40:60 or less, or 30:70 or less, or 20:80 or less.

### Additional Components

The aqueous dispersion may optionally comprise one or more additional components such polymer solids (e.g., a wax such as ethylene bis(stearamide) or N,N′ ethylene bisstearamide), other water-based dispersions, pigments, wetting agents, defoamers, solvents, rheology modifiers, surfactants, anti-oxidants, and other processing aids to improve barrier and performance attributes of the dispersion, films formed from the dispersion and articles coated with the films.

### Method of Forming a Film

As explained above, the aqueous dispersion may be used to form a film and/or to coat a substrate or article with such a film. Accordingly, a method of forming a film using the aqueous dispersion comprises steps of applying the aqueous dispersion to an article and curing the aqueous dispersion at a temperature of 10° C. to 50° C. to form a film.

The aqueous dispersion may be applied to the article in a variety of manners. For example, the articles may be submerged in the aqueous dispersion or the aqueous dispersion can be sprayed onto the article. It will be understood that multiple coats or applications of the aqueous dispersion to the article may be performed. The aqueous dispersion may be used to form a film on a variety of types of articles. For example, the article may include a seed, a paper article, and a crop additive (e.g., a fertilizer, crop adjuvant, pesticide, etc.). The aqueous dispersion may also be cast onto surface to form films directly on the surface.

After the aqueous dispersion has been applied to the article, the dispersion is cured to form the film. The curing of the aqueous dispersion may be performed at a temperature of 10° C. to 50° C. to form to film. For example, the curing temperature may be 10° C. or greater, or 15° C. or greater, or 20° C. or greater, or 25° C. or greater, or 30° C. or greater, or 35° C. or greater, or 40° C. or greater, while at the same time, 50° C. or less, or 45° C. or less, or 40° C. or less, or 35° C. or less, or 30° C. or less, or 25° C. or less, or 20° C. or less, or 15° C. or less. As highlighted above, the aqueous dispersion may cure and form the film at a temperature of 10° C. to 50° C. due to the increased chain mobility of the polyester (i.e., because it has a glass transition temperature below 50° C.) which allows the amino groups present on the polyamine to essentially crosslink the polyester particles together. Such a feature is advantageous in that articles which would be damaged by high temperature curing (e.g., seeds, paper products, etc.) will not be damaged by curing the aqueous dispersion. It will be understood that the curing of the aqueous dispersion into the film may be done at temperatures exceeding 50° C.

The film formed from the cured aqueous dispersion may exhibit a variety of beneficial properties. For example, the film may exhibit a turbidity value of 50 or less, or 45 or less, or 40 or less, or 35 or less, or 30 or less, or 25 or less, or 20 or less, or 15 or less, or 10 or less, or 5 or less or 0 as measured according to Turbidity Testing. Additionally, the film may exhibit a visual rating of 5 or greater, or 6 or greater, or 7 or greater, or 8 or greater, or 9 or greater or 10 as measured according to Visual Water Resistance Testing.

### EXAMPLES

### Materials

Below are the materials used in the formation of the inventive examples (“IE”) and the comparative examples (“CE”).

PLA is polylactic acid having a weight average molecular weight of 155,000 Da and is commercially available as Ingeo™ Biopolymer 4032D by NatureWorks, Plymouth, Minnesota.

PCL is polycaprolactone having a weight average molecular weight of 25,000 g/mol and is commercially available as CAPA™ 6250 from Ingevity, North Charleston, South Carolina.

PVOH1 is polyvinyl alcohol and is commercially available as POVAL™ 4-88 from Kuraray Co., Ltd, Tokyo, Japan.

PVOH2 is polyvinyl alcohol and is commercially available as POVAL™ 6-88 from Kuraray Co., Ltd, Tokyo, Japan.

PVOH3 is polyvinyl alcohol and is commercially available as POVAL™ 18-88 from Kuraray Co., Ltd, Tokyo, Japan.

PA1 is branched polyethylenimine having a number average molecular weight of 800 g/mol and 18 primary, secondary, and tertiary amino functional sites and is commercially available from Sigma-Aldrich, St. Louis, Missouri.

PA2 is branched polyethylenimine having a number average molecular weight of 25.00 g/mol and 581 primary, secondary, and tertiary amino functional sites and is commercially available from Sigma-Aldrich, St. Louis, Missouri.

DETA is diethylenetriamine having a CAS number of 111-40-0 and 3 amino functional sites and is commercially available from Sigma-Aldrich, St. Louis, Missouri.

Jeffamine is bis(2-aminopropyl) polypropylene glycol-block-polyethylene glycol-block-polypropylene glycol having a weight average molecular weight of 1900 g/mol, a CAS number of 65605-36-9 and two amino functional groups and is commercially available from Sigma-Aldrich, St. Louis, Missouri.

### Dispersion Preparation

Polyester dispersion components for IE1-IE6 and CE1-CE8 have the polymer phase components and physical properties as shown in Table 2, are formed from the raw materials listed above, and were prepared according to the general procedure, process, and conditions described herein. The polyester resin and PVOH listed for each example in Table 2 are fed into a 25 mm diameter twin screw extruder using a controlled rate feeder at the given ratios listed in Table 2 at a total feed rate of 75.6 g/min. The solid components are forwarded through the extruder and melted to form a liquid melt material where the melt zone temperature in the extruder is set to be greater than the melting temperature of the PVOH material. An initial amount of water is then added into the extruder at a rate roughly equal to the feed rate of the PVOH material. In a later section of the extruder additional dilution water is then added at a rate to give the composition percentage solids as indicated in Table 2. The extruder speed used was 600 rpm. At the extruder outlet, a backpressure regulator is used to adjust the pressure inside the extruder barrel to a pressure adapted to reduce steam formation (generally the pressure was from 2 MPa to 4 MPa). Each polyester dispersion exits from the extruder and is filtered first through a 200 micrometer (μm) filter. The resultant filtered polyester dispersion has a solids content measured in weight percent (wt %); and the solids particles of the polyester dispersion has a volume mean particle size measured in microns. The solids content of the polyester dispersion is measured using an infrared solids analyzer, and the particle size of the solids particles of the polyester dispersion is measured using a COULTER™ LS-230 particle size analyzer (Beckman Coulter Corporation, Fullerton, CA). The solids content and the average particle size (PS) of the solids particles of the polyester dispersion composition are indicated in Table 2.

### Sample Preparation

The polyester dispersion was mixed with or without the selected polyamine according to Table 1. The samples were stored in a cabinet overnight. Five grams of each example were sampled and had 0.12 grams of a red pigment dispersion (as an indicator for later Visual Water Resistance Testing and Turbidity Testing) added. After mixing in a vortex mixer for 5 minutes, 3 grams of each sample was poured into separate 47 mm petri dishes and dried overnight in a fume hood exposed to open air at 23° C. to cast films.

### Test Methods

### Visual Water Resistance Testing

For water resistance testing, a rectangular stripe of film of about 0.2 g was cut out and placed in a vial. Ten mL of deionized water was added to the vial. Color and appearance of the water were observed at 5, 30 and 60 minutes. The vials were gently swirled by hand every 5 minutes. Water resistance was visually ranked in the range of 1-10, with 1 as not water resistant at all and 10 as excellent water resistance. For samples that disintegrated completely in the first 5 minutes, a rating of 1-2 was assigned. Samples did not disintegrate in 5 min but broke into pieces, and show red color and turbidity at 30 minutes were assigned a number of 3-6. Samples that did not show disintegration at 60 minutes were given ratings from 7-10 depending on the color and clarity of the liquid.

### Turbidity Testing

To quantitatively describe water resistance, turbidity measurement was employed. Turbidity testing was performed by was cutting out 0.2 g pieces of the cast film and placed in a vial. Twenty mL of deionized water was added to each vial. After 60 minutes, the vials were gently swirled by hand before 3 mL of supernatant was withdrawn from each vial and added to 30 mL turbidity tubes. The tubes were then filled with deionized water to 30 mL and turbidity was measured on a Hach Ratio Turbidimeter. The test was repeated 3 times involving 3 separate pieces cut from the same cast film. The measure range of the Turbidimeter is 0-200. The turbidity was recorded as 200 for samples that were out of range.

### Particle Size Testing

Particle size is measured by laser diffraction using a COULTER™ LS-230 particle size analyzer (Beckman Coulter Corporation, Fullerton, CA) with the particle (sample) refractive index set to 1.5 and is reported as the volume mean diameter of the polyester particles.

### Glass Transition Temperature

Glass transition temperature is measured according to ASTM E1356-08 (2014).

### Results

Table 1 provides the composition of IE1-IE6 and CE1-IE8 as well as the associated performance results. Table 2 provides information about the polyester dispersion including the “PE/DA” column which is the relative weight ratio of the polyester to dispersing agent based on the combined weight of the polyester and dispersing agent.

TABLE 1

| | | | Polyamine | Visual | Turbidity |
|---|---|---|---|---|---|
| Ex. | Composition | Polyamine | (wt %) | Rating | Value |
| CE1 | PLA/PVOH1 | N/A | NA | 1 | 200 |
| CE2 | PLA/PVOH1 | N/A | NA | 1 | 200 |
| CE3 | PLA/PVOH1 | PA1 | 1.0 wt % | 3 | 75 |
| CE4 | PLA/PVOH1 | PA1 | 1.0 wt % | 4 | 38 |
| CE5 | PCL/PVOH2 | N/A | NA | 1 | 200 |
| CE6 | PCL/PVOH2 | Jeffamine | 1.0 wt % | 4 | 57 |
| IE1 | PCL/PVOH2 | DETA | 0.5 wt % | 8 | 3.3 |
| IE2 | PCL/PVOH2 | PA1 | 1.0 wt % | 8 | 3.1 |
| IE3 | PCL/PVOH2 | PEI 25000 | 1.0 wt % | 7 | 7.5 |
| CE7 | PCL/PVOH3 | N/A | NA | 1 | 200 |
| CE8 | PCL/PVOH3 | Jeffamine | 1.0 wt % | 3 | 76 |
| IE5 | PCL/PVOH3 | PA1 | 1.0 wt % | 8 | 3.1 |
| IE6 | PCL/PVOH3 | DETA | 0.5 wt % | 8 | 2.7 |

TABLE 2

| | PE/DA | Total dispersion solid | |
|---|---|---|---|
| Composition | ratio | content (wt %) | Vmean (nm) |
| PLA/PVOH1 | 80/20 | 45 | 1691 |
| PLA/PVOH1 | 70/30 | 34 | 500 |
| PCL/PVOH2 | 70/30 | 38 | 191 |
| PCL/PVOH3 | 70/30 | 40 | 399 |

Referring now to Table 1, CE1, CE2, CE5, and CE7 all demonstrate that the lack of polyamine in the aqueous dispersion leads to the formation of films which are not readily water resistant regardless of polyester type. This fact is clear from the low visual rating as well as the high turbidity values. CE3 and CE4 demonstrate that the high glass transition temperature of polylactic acid (60° C. to 65 C) is too high to provide sufficient chain mobility for polyamine crosslinking even when utilizing a polyamine having 3 or greater amino groups. CE6 and CE8 demonstrate that the use of a polyamine having only 2 amino groups is unable to provide satisfactory results despite utilizing a polyester having a glass transition temperature of 50° C. or less (i.e., polycaprolactone).

Referring now to IE1-IE6, it is self-evident that an aqueous dispersion comprising a polyamine having 3 or more amino groups and plurality of particles of polyester having a glass transition temperature of 50° C. or less or less as measured according to ASTM E1356-08 is able to achieve the turbidity value of 50 or less as measured according to Turbidity Testing and a visual rating of 5 or greater as measured according to Visual Water Resistance Testing without the need for a cure step above 50° C. As explained above, it is believed that the polyamines react and bind to the surface of the polyester particles via aminolysis. Upon drying, the particles get close to each other and the unreacted amino groups on one particle will react and bind to one adjacent particle to facilitate film forming.

What is claimed is:

1. An aqueous dispersion, comprising:
water;
a dispersing agent;
a polyamine having 3 or more amino groups; and
a plurality of particles of polyester, wherein the polyester is aliphatic and has a glass transition temperature of 50° C. or less or less as measured according to ASTM E1356-08.

2. The aqueous dispersion of claim 1, wherein the dispersing agent is selected from the group consisting of polyvinyl alcohol, fatty alcohol ethoxylates, ethylene oxide/propylene oxide block copolymers, salts of fatty acids and mixtures thereof.

3. The aqueous dispersion of claim 1, wherein the polyester particles have a volume mean size of from 100 nm to 1500 nm as measured according to Particle Size Testing.

4. The aqueous dispersion of claim 1, wherein the aqueous dispersion comprises:
1 wt % to 20 wt % of the dispersing agent based on the total weight of the aqueous dispersion;
0.05 wt % to 5 wt % of the polyamine based on the total weight of the aqueous dispersion; and
20 wt % to 60 wt % of the polyester particles based on the total weight of the aqueous dispersion.

5. The aqueous dispersion of claim 1, wherein the polyamine is selected from the group consisting of polyethylenimine, chitosan, diethylenetriamine, triethylenetetramine and combinations thereof.

6. The aqueous dispersion of claim 1, wherein the aqueous dispersion comprises from 0.1 wt % to 1.0 wt % of the polyamine based on a total weight of the aqueous dispersion.

7. The aqueous dispersion of claim 1, wherein the glass transition temperature is from −70° C. to 20° C.

8. The aqueous dispersion of claim 1, wherein the polyester is selected from the group consisting of polycaprolactone, poly(3-hydroxybutyrate-co-3-hydroxyhexanoate), poly(3-hydroxybutyrate-co-3-hydroxy valerate), polyhydroxyalkanoate, polybutylene adipate terephthalate, polybutylene succinate, polybutylene succinate adipate, poly(3-hydroxybutyrate), and mixtures thereof.

9. A method of forming a film, comprising the steps of:
applying the aqueous dispersion of claim 1 to an article; and
curing the aqueous dispersion at a temperature of 10° C. to 50° C. to form a film.

10. The method of claim 9, wherein the article is selected from the group consisting of a seed, a paper article, and a crop additive.
